(19) United States
(12) Patent Application Publication
(10) Pub. No.: US 2024/0406969 A1
(43) Pub. Date: Dec. 5, 2024

(54) INFORMATION ACTIVATION METHOD, TERMINAL, AND NETWORK SIDE DEVICE

(71) Applicant: VIVO MOBILE COMMUNICATION CO., LTD., Dongguan (CN)

(72) Inventors: Yu YANG, Dongguan (CN); Yang SONG, Dongguan (CN); Hao LIU, Dongguan (CN)

(73) Assignee: VIVO MOBILE COMMUNICATION CO., LTD., Dongguan (CN)

(21) Appl. No.: 18/800,119

(22) Filed: Aug. 11, 2024

Related U.S. Application Data
(63) Continuation of application No. PCT/CN2023/075426, filed on Feb. 10, 2023.

(30) Foreign Application Priority Data
Feb. 11, 2022 (CN) 202210130268.1

(51) Int. Cl. H04W 72/231; H04L 5/00

(52) U.S. Cl. CPC H04W 72/231; H04L 5/0053

(57) ABSTRACT

An information activation method, a network side device, and a non-transitory computer-readable storage medium are provided. The information activation method includes: sending, by a network side device, a Media Access Control Control Element (MAC CE) command. The MAC CE command includes at least two first MAC CE commands or a second MAC CE command. The first MAC CE command is used to activate a Transmission Configuration Indicator (TCI) state corresponding to one piece of first identifier information. The second MAC CE command is used to activate TCI states corresponding to at least two pieces of second identifier information. The activated TCI state is used to determine common beam information of a plurality of channels.

### CROSS-REFERENCE TO RELATED APPLICATIONS

This application is a continuation of International Application No. PCT/CN2023/075426, filed on Feb. 10, 2023, which claims priority to Chinese Patent Application No. 202210130268.1, filed on Feb. 11, 2022. The entire contents of each of the above-referenced applications are expressly incorporated herein by reference.

### TECHNICAL FIELD

This application pertains to the field of communication technologies, and specifically relates to an information activation method, a terminal, and a network side device.

### BACKGROUND

After beam measurement and beam reporting, a network may perform beam indication on a downlink and an uplink channel or reference signal, to establish a beam link between the network and User Equipment (UE), so as to implement transmission of the channel or reference signal. In a unified Transmission Configuration Indicator (TCI) framework, the network may use a same beam indicated by a Media Access Control Control Element (MAC CE) and/or Downlink Control Information (DCI) to perform multi-channel transmission, where beam information may generally be represented by TCI state information.

Currently, a same beam may be used for multi-channel transmission but support only a single Transmission Reception Point (TRP) scenario. There is no solution of how to support a multi-TRP scenario.

### SUMMARY

Embodiments of this application provide an information activation method, a terminal, and a network side device.

According to a first aspect, an information activation method is provided. The method includes:
sending, by a network side device, a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

According to a second aspect, an information activation apparatus is provided, including:
a sending module, configured to send a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

According to a third aspect, an information activation method is provided. The method includes:
receiving, by a terminal, a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

According to a fourth aspect, an information activation apparatus is provided, including:
a receiving module, configured to receive a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

According to a fifth aspect, a network side device is provided. The network side device includes a processor and a memory, the memory stores a program or an instruction that can be run on the processor, and the program or the instruction is executed by the processor to implement the steps of the method according to the first aspect.

According to a sixth aspect, a network side device is provided, including a processor and a communication interface. The communication interface is configured to send a Media Access Control control element MAC CE command, where the MAC CE command includes at least two first MAC CE commands or a second MAC CE command; the first MAC CE command is used to activate a transmission configuration indicator TCI state corresponding to one piece of first identifier information; the second MAC CE command is used to activate TCI states corresponding to at least two pieces of second identifier information; and the activated TCI state is used to determine common beam information of a plurality of channels.

According to a seventh aspect, a terminal is provided. The terminal includes a processor and a memory, the memory stores a program or an instruction that can be run on the processor, and the program or the instruction is executed by the processor to implement the steps of the method according to the third aspect.

According to an eighth aspect, a terminal is provided, including a processor and a communication interface. The communication interface is configured to receive a Media Access Control control element MAC CE command, where the MAC CE command includes at least two first MAC CE commands or a second MAC CE command; the first MAC CE command is used to activate a transmission configuration indicator TCI state corresponding to one piece of first identifier information; the second MAC CE command is used to activate TCI states corresponding to at least two pieces of second identifier information; and the activated TCI state is used to determine common beam information of a plurality of channels.

According to a ninth aspect, a communication system is provided, including a terminal and a network side device. The terminal may be configured to perform the steps of the information activation method according to the third aspect, and the network side device may be configured to perform the steps of the information activation method according to the first aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the method according to the first aspect or implement the method according to the third aspect.

According to a twelfth aspect, a computer program product is provided. The computer program product is stored in a storage medium, and the computer program product is executed by at least one processor to implement the steps of the method according to the first aspect or the third aspect.

In the embodiments of this application, a network side device sends a MAC CE command, where the MAC CE command includes at least two first MAC CE commands or a second MAC CE command; the first MAC CE command is used to activate a TCI state corresponding to one piece of first identifier information; the second MAC CE command is used to activate TCI states corresponding to at least two pieces of second identifier information; and the activated TCI state is used to determine common beam information of a plurality of channels. In a multi-TRP scenario, the activated TCI state includes a TCI state that is of each TRP and that is used for multi-channel transmission, so that a same beam on each TRP can be used for multi-channel transmission in the multi-TRP scenario.

### BRIEF DESCRIPTION OF DRAWINGS

FIG. 1 is a block diagram of a wireless communication system to which the embodiments of this application can be applied;

FIG. 2 is a first flowchart of an information activation method according to an embodiment of this application;

FIG. 3 is a second flowchart of an information activation method according to an embodiment of this application;

FIG. 4 is a first structural diagram of an information activation apparatus according to an embodiment of this application;

FIG. 5 is a second structural diagram of an information activation apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

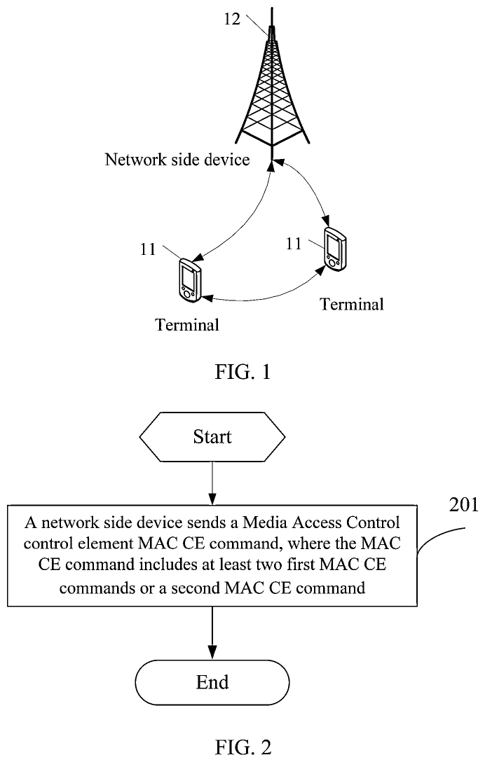

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device 12 may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNodeB, a TRP, or another appropriate term in the field. As long as a same technical effect is achieved, the base station is not limited to a specified technical term. It should be noted that, in this application, only a base station in an NR system is used as an example, and a specific type of the base station is not limited. With reference to the accompanying drawings, the following describes in detail an information activation method provided in the embodiments of this application by using some embodiments and application scenarios thereof.

As shown in FIG. 2, an embodiment of this application provides an information activation method, including the following steps:

Step 101: A network side device sends a MAC CE command, where the MAC CE command includes at least two first MAC CE commands or a second MAC CE command.

The first MAC CE command is used to activate a TCI state corresponding to one piece of first identifier information, and the second MAC CE command is used to activate TCI states corresponding to at least two pieces of second identifier information; and the activated TCI state is used to determine common beam information of a plurality of channels.

The MAC CE command includes two cases. In one case, the MAC CE command includes at least two first MAC CE commands, and each first MAC CE command is used to activate a TCI state corresponding to one piece of first identifier information. This may be understood as a one-to-one correspondence between the first MAC CE command and the first identifier information. For example, the network side device may use a first MAC CE command corresponding to each TRP Identifier (ID) (for example, a Radio Resource Control (RRC) parameter: Control Resource Set Pool Index (CORESETPoolIndex)) to activate a TCI state corresponding to each TRP ID. Further, the network side device further uses DCI on a Physical Downlink Control Channel (PDCCH) corresponding to the same TRP ID as the first MAC CE command to indicate a target TCI state corresponding to the TRP ID in TCI states activated by the first MAC CE command. In the other case, the MAC CE command includes a second MAC CE command, and the second MAC CE command is used to activate TCI states corresponding to at least two second TRP IDs. This may be understood as a one-to-many correspondence between a second MAC CE command and second TRP IDs.

In this application, the at least two first MAC CE commands may be understood as follows: One MAC CE command is sent at a time, and MAC CE commands sent for different times may have a same MAC Packet Data Unit (PDU) subheader that carries an extended Logical Channel Identifier (eLCID), or may have different MAC PDU subheaders that carry an eLCID.

The activated TCI state includes at least one of a joint TCI state and a separate TCI state.

The activated TCI state includes a target TCI state, and the target TCI state is a TCI state used for multi-channel transmission, which may be understood as common beam information shared by a plurality of channels.

In this embodiment of this application, a network side device sends a MAC CE command, where the MAC CE command includes at least two first MAC CE commands or a second MAC CE command; the first MAC CE command is used to activate a TCI state corresponding to one piece of first identifier information; the second MAC CE command is used to activate TCI states corresponding to at least two pieces of second identifier information; and the activated TCI state is used to determine common beam information of a plurality of channels. In a multi-TRP scenario, the activated TCI state includes a TCI state that is of each TRP and that is used for multi-channel transmission, so that a same beam on each TRP can be used for multi-channel transmission in the multi-TRP scenario.

In the foregoing, the first identifier information includes at least one of the following:
Control Resource Set (CORESET) identifier information;
a CORESETPoolIndex;
TRP identifier information;
channel group identifier information;
CORESET group identifier information; and
Physical Uplink Control Channel (PUCCH) resource group identifier information; and
the second identifier information includes at least one of the following:
CORESET identifier information;
CORESETPoolIndex;
TRP identifier information;
channel group identifier information;
CORESET group identifier information; and
PUCCH resource group identifier information.

The information activation method provided in this embodiment of this application may be used in a multi-TRP DCI scenario. For example, the network side device configures two CORESETPoolIndex by using RRC signaling, where a value of one CORESETPoolIndex is 0, a value of the other CORESETPoolIndex is 1, and each CORESETPoolIndex may be used as an identifier (ID) of one TRP.

It should be noted that the multi-TRP scenario may be indirectly identified by configuring various parameters. For example, RRC parameters CORESETPoolIndex 0 and 1 are configured for multi-DCI (that is, mDCI) of multi-TRPs, so that two TRPs are indirectly identified and the mDCI scenario is determined.

The first MAC CE command includes a field used to indicate an identifier of a first TRP. For example, the first MAC CE command includes a field that indicates CORESETPoolIndex.

In an embodiment of this application, in a case that the network side device configures a joint TCI mode, that is, configures the joint TCI mode for all TRPs (all first identifier information), each TCI state activated according to the first MAC CE command corresponds to one codepoint. In other words, one TCI state in TCI states activated by the first MAC CE command corresponds to one codepoint, and the TCI state activated by the first MAC CE command is used for a TRP corresponding to first identifier information indicated in the first MAC CE command, that is, the TCI state activated by the first MAC CE command is used for the first identifier information indicated by the first MAC CE command.

In an embodiment of this application, in a case that the network side device configures a separate TCI mode, that is, configures the separate TCI mode for all TRPs (all first identifier information), each TCI state and codepoint activated according to the first MAC CE command meet one of the following:
one codepoint corresponds to one pair of TCI states, where the one pair of TCI states include a Downlink (DL) TCI state and an Uplink (UL) TCI state;
one codepoint corresponds to one DL TCI state; and
one codepoint corresponds to one UL TCI state.

In the foregoing, the TCI state activated by the first MAC CE command is used for a TRP corresponding to first identifier information indicated by the first MAC CE command, that is, the TCI state activated by the first MAC CE command is used for the first identifier information indicated by the first MAC CE command.

In an embodiment of this application, the network side device is allowed to configure a joint TCI mode for a part of TRPs (a part of first identifier information) and configure a separate TCI mode for another part of TRPs (another part of first identifier information), each TCI state and codepoint activated according to the first MAC CE command meet one of the following:
one codepoint corresponds to one joint TCI state;
one codepoint corresponds to one separate DL TCI state and one separate UL TCI state;
one codepoint corresponds to one separate DL TCI state; and
one codepoint corresponds to one separate UL TCI state.

In this embodiment, because the network side device does not configure a joint TCI mode or a separate TCI mode for the first identifier information, a manner of distinguishing whether a TCI state corresponding to a codepoint is joint or separate may be: distinguishing a joint TCI state, a separate DL TCI state, or a separate UL TCI state according to that TCI states are from different TCI state pools. For example, at least two of the joint TCI state, the separate DL TCI state, and the separate UL TCI state are from different TCI state pools.

Indication information may be added to the first MAC CE command to distinguish whether a TCI state corresponding to a codepoint is joint or separate. For example, the first MAC CE command includes first indication information, and the first indication information is used to indicate that a TCI state corresponding to a codepoint is one of the following:
the joint TCI state;
the separate DL TCI state and the separate UL TCI state;
the separate DL TCI state; and
the separate UL TCI state.

In an embodiment of this application, the network side device uses the second MAC CE command to activate TCI states corresponding to all TRP IDs, and the network side device uniformly configures a joint TCI mode for all second identifier information by using RRC signaling. That is, in a case that the network side device configures a joint TCI mode for the at least two pieces of second identifier information, a TCI state and a codepoint activated according to the second MAC CE command meet one of the following:
(1) One codepoint corresponds to at least two TCI states, and each TCI state in the at least two TCI states corresponds to different second identifier information. In an example in which the second identifier information is TRP identifier information, a codepoint 1 corresponds to a TCI state 1 and a TCI state 2, where the TCI state 1 is used as a joint TCI state corresponding to a TRP 1, and the TCI state 2 is used as a joint TCI state corresponding to a TRP 2. The TCI state corresponding to the second identifier information includes one joint TCI state.

(2) Each codepoint corresponds to a TCI state corresponding to one piece of second identifier information. For example, a TCI state corresponding to a codepoint 1 is used as a joint TCI state corresponding to a TRP 1, and a TCI state corresponding to a codepoint 2 is used as a joint TCI state corresponding to a TRP 2. The TCI state corresponding to the second identifier information includes one joint TCI state.

In an embodiment of this application, the network side device uses the second MAC CE command to activate TCI states corresponding to all second identifier information, and the network side device uniformly configures a separate TCI mode for all the second identifier information by using RRC signaling. That is, in a case that the network side device configures a separate TCI mode for the at least two pieces of second identifier information, a TCI state and a codepoint activated according to the second MAC CE command meet one of the following:
(1) One codepoint corresponds to TCI states corresponding to a plurality of pieces of second identifier information in the at least two pieces of second identifier information, where the TCI state corresponding to the second identifier information includes at least one of one DL TCI state and one UL TCI state.

For example, a codepoint 1 corresponds to a TCI state 1, a TCI state 2, a TCI state 3, a TCI state 4, where the TCI state 1 and the TCI state 2 are used as a separate DL TCI state and a separate UL TCI state corresponding to a TRP 1, and the TCI state 3 and the TCI state 4 are used as a separate DL TCI state and a separate UL TCI state corresponding to a TRP 2.
(2) Each codepoint corresponds to a TCI state corresponding to one piece of second identifier information, where the TCI state corresponding to the second identifier information includes at least one of one DL TCI state and one UL TCI state.

For example, in an example in which the second identifier information is TRP identifier information, two TCI states corresponding to a codepoint 1 are used as a separate DL TCI state and a separate UL TCI state corresponding to a TRP 1, and two TCI states corresponding to a codepoint 2 are used as a separate DL TCI state and a separate UL TCI state corresponding to a TRP 2.

In an embodiment of this application, the network side device uses the second MAC CE command to activate TCI states corresponding to all second identifier information, and the network side device configures a separate TCI mode for a part of second identifier information and configures a joint TCI mode for another part of second identifier information by using RRC signaling. That is, first target identifier information includes a part of second identifier information in the at least two pieces of second identifier information, and the second target identifier information is other second identifier information in the at least two pieces of second identifier information except the first target identifier information.

In a case that the network side device configures a joint TCI mode for the first target identifier information and configures a separate TCI mode for the second target identifier information, a TCI state and a codepoint activated according to the second MAC CE command meet one of the following:
(1) One codepoint corresponds to a joint TCI state corresponding to the first target identifier information and a separate TCI state of second identifier information in the second target identifier information.
(2) A first codepoint corresponds to a joint TCI state corresponding to the first target identifier information, and a second codepoint corresponds to a separate TCI state corresponding to the second target identifier information, where the first codepoint is a part of codepoints in codepoints activated by the second MAC CE command, and the second codepoint is a codepoint in the codepoints activated by the second MAC CE command except the first codepoint.

In an embodiment of this application, the network side device does not configure a joint TCI mode or a separate TCI mode for the second identifier information. In this case, each TCI state and codepoint activated according to the second MAC CE command meet one of the following:
(1) A TCI state corresponding to one codepoint includes a TCI state corresponding to each piece of second identifier information in the at least two pieces of second identifier information, where the TCI state corresponding to the second identifier information includes one of the following:
a joint TCI state;
a separate DL TCI state and a separate UL TCI state;
a separate DL TCI state; and
a separate UL TCI state.
(2) A third codepoint corresponds to a TCI state corresponding to one piece of second identifier information, and a fourth codepoint corresponds to a TCI state corresponding to another piece of second identifier information, where the third codepoint and the fourth codepoint are different codepoints in codepoints activated by the second MAC CE command, the TCI state corresponding to the one piece of second identifier information includes a joint TCI state, and the TCI state corresponding to the another piece of second identifier information includes at least one of one separate DL TCI state and one separate UL TCI state.

In this embodiment, because the network side device does not configure a joint TCI mode or a separate TCI mode for the second identifier information, a manner of distinguishing whether a TCI state corresponding to a codepoint is joint or separate may be: distinguishing a joint TCI state, a separate DL TCI state, or a separate UL TCI state according to that TCI states are from different TCI state pools. For example, at least two of the joint TCI state, the separate DL TCI state, and the separate UL TCI state are from different TCI state pools. In some alternative embodiments, indication information is added to the second MAC CE command for indication. For example, the second MAC CE command includes second indication information, and the second indication information is used to indicate that a TCI state corresponding to a codepoint is one of the following:
the joint TCI state;
the separate DL TCI state and the separate UL TCI state;
the separate DL TCI state; and
the separate UL TCI state.

In an embodiment of this application, a correspondence between a TCI state activated by the second MAC CE command and the at least two pieces of second identifier information is determined according to one of the following:
(1) Third indication information included in the second MAC CE command, where the third indication information is used to indicate a correspondence between a codepoint and second identifier information, or is used to indicate a correspondence between a TCI state activated by the second MAC CE command and second identifier information.
(2) An association relationship between a location or a sequence of each TCI state in a plurality of TCI states corresponding to one codepoint and an identifier of each piece of second identifier information. The location or the sequence of each TCI state herein means that when one codepoint corresponds to a plurality of TCI states, the plurality of TCI states are arranged in a sequence, and there is an association relationship between arrangement sequences or arrangement locations of these TCI states and each piece of second identifier information.
(3) An association relationship between a location or a sequence of a codepoint and an identifier of each piece of second identifier information. The location or the sequence of the codepoint herein means that when the network activates a plurality of TCI codepoints by using a MAC CE, the codepoints are arranged in a sequence, and there is an association relationship between arrangement sequences or arrangement locations of the codepoints and each piece of second identifier information.

It should be noted that in a case that the network side device configures a separate TCI mode for the second identifier information, the activated TCI state may be default. For example, only a separate DL TCI state is activated, or only a separate UL TCI state is activated. If only the separate DL TCI state is activated, the separate UL TCI state may be default, and the default separate UL TCI state is the same as the last activated separate UL TCI state. If only the separate UL TCI state is activated, the separate DL TCI state may be default, and the default separate DL TCI state is the same as the last activated separate DL TCI state.

In an embodiment of this application, the method further includes: sending, by the network side device, first configuration information, where the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

In other words, the network side device may uniformly configure a joint TCI mode or a separate TCI mode for all first identifier information or all second identifier information at one time. In the case of unified configuration, each piece of identifier information is in a joint TCI mode or a separate TCI mode, and all the first identifier information or all the second identifier information shares one piece of first configuration information. In some alternative embodiments, the network side device may separately configure a joint TCI mode or a separate TCI mode for each piece of first identifier information or each piece of second identifier information. In the case of separate configuration, TCI modes of each piece of identifier information may be the same or different, and each piece of first identifier information or second identifier information is configured with one piece of first configuration information.

When the network side device configures the first identifier information or the second identifier information, a configuration manner of the configuration includes at least one of the following:
an association relationship is established between third target identifier information and configuration information of the joint TCI mode;
an association relationship is established between the third target identifier information and configuration information of the separate TCI mode;
the configuration information of the joint TCI mode is included in the third target identifier information;
the configuration information of the separate TCI mode is included in the third target identifier information;
the third target identifier information is included in the configuration information of the joint TCI mode; and
the third target identifier information is included in the configuration information of the separate TCI mode.

The third target identifier information is the first identifier information, or the third target identifier information is any one piece of identifier information in the at least two pieces of second identifier information.

In an embodiment of this application, the method further includes: sending, by the network side device, target DCI, where the target DCI is used to indicate a target TCI state in the activated TCI states.

In an implementation, the target DCI is DCI transmitted on a CORESET corresponding to fourth target identifier information, and is used to indicate a target TCI state corresponding to fifth target identifier information, where both the fourth target identifier information and the fifth target identifier information are the first identifier information; and the target TCI state is at least one of TCI states activated by a first target MAC CE command, and the first target MAC CE command is a first MAC CE command corresponding to the fifth target identifier information in the at least two first MAC CE commands. The fourth target identifier information and the fifth target identifier information may be the same. For example, in an example in which the first identifier information is TRP identifier information, DCI transmitted on a CORESET corresponding to a TRP ID 1 is used to indicate a TCI state activated by a first MAC CE command corresponding to the TRP ID 1, and DCI transmitted on a CORESET corresponding to a TRP ID 2 is used to indicate a TCI state activated by a first MAC CE command corresponding to the TRP ID 2. The fourth target identifier information and the fifth target identifier information may also be different. The fifth target identifier information may include one piece of first identifier information, or may include a plurality of pieces of first identifier information.

In another implementation, the target DCI is DCI transmitted on a CORESET corresponding to sixth target identifier information, and is used to indicate a target TCI state corresponding to each piece of second identifier information in the at least two pieces of second identifier information, where the sixth target identifier information is identifier information or any one piece of identifier information in the at least two pieces of second identifier information. The target DCI may be transmitted by using a PDCCH on a CORESET corresponding to identifier information or any one piece of identifier information, and is used to indicate TCI states activated by MAC CEs corresponding to all identifier information IDs.

In an embodiment of this application, the first MAC CE command includes a first signaling field, and the first signaling field is used to indicate the target TCI state in TCI states activated by the first MAC CE command; or
the second MAC CE command includes a first signaling field, and the first signaling field is used to indicate the target TCI state in TCI states activated by the second MAC CE command; or
the target DCI includes a first signaling field, and the first signaling field is used to indicate the target TCI state in TCI states corresponding to a codepoint indicated by a TCI field of the target DCI.

In the foregoing, whether the first MAC CE command includes the first signaling field is determined according to at least one of the following:
(1) Configuration information of the network side device. For example, the network side device may configure, by using the configuration information, that the first MAC CE command includes the first signaling field.
(2) A quantity of TCI states activated by the first MAC CE command. For example, in a joint TCI mode, if the quantity of TCI states activated by the first MAC CE command is equal to 1, the activated TCI state is the target TCI state, the first signaling field is not required to indicate the target TCI state, and the first MAC CE command does not include the first signaling field. If the quantity of TCI states activated by the first MAC CE command is greater than 1, the first MAC CE command includes the first signaling field.

Whether the second MAC CE command includes the first signaling field is determined according to at least one of the following:
(1) Configuration information of the network side device. For example, the network side device may configure, by using the configuration information, that the second MAC CE command includes the first signaling field.
(2) A quantity of TCI states activated by the second MAC CE command. For example, in a joint TCI mode, if the quantity of TCI states activated by the second MAC CE command is equal to 1, the activated TCI state is the target TCI state, the first signaling field is not required to indicate the target TCI state, and the second MAC CE command does not include the first signaling field. If the quantity of TCI states activated by the second MAC CE command is greater than 1, the second MAC CE command includes the first signaling field.

Whether the target DCI includes the first signaling field is determined according to at least one of the following:
(1) Configuration information of the network side device. For example, the network side device may configure, by using the configuration information, that the target DCI includes the first signaling field.
(2) A quantity of TCI states activated by the first MAC CE command.
(3) A quantity of TCI states activated by the second MAC CE command.
(4) A quantity of TCI states corresponding to the codepoint indicated by the TCI field of the target DCI.

In the foregoing, in a case that the first MAC CE includes the first signaling field, the first signaling field is used to indicate one of the following:
one joint TCI state, or one pair of separate TCI states, or one separate UL TCI state, or one separate DL TCI state in the TCI states activated by the first MAC CE command;
all TCI states activated by the first MAC CE command; and
all TCI states activated by the first MAC CE command, and a sequence or a location of each TCI state;
or
in a case that the second MAC CE includes the first signaling field, the first signaling field is used to indicate one of the following:
one joint TCI state, or one pair of separate TCI states, or one separate UL TCI state, or one separate DL TCI state in the TCI states activated by the second MAC CE command;
all TCI states activated by the second MAC CE command; and
all TCI states activated by the second MAC CE command, and a sequence or a location of each TCI state;
or
in a case that the target DCI includes the first signaling field, the first signaling field is used to indicate one of the following:
one joint TCI state, or one pair of separate TCI states, or one separate UL TCI state, or one separate DL TCI state in the TCI states corresponding to the codepoint indicated by the TCI field of the target DCI;
all TCI states corresponding to the codepoint indicated by the TCI field of the target DCI; and
all TCI states corresponding to the codepoint indicated by the TCI field of the target DCI, and a sequence or a location of each TCI state.

In an embodiment of this application, the target DCI is UL DCI, and is used to indicate a target TCI state in TCI states activated by the first MAC CE command or the second MAC CE command. The first signaling field is a Sounding Reference Signal (SRS) resource set indicator field in the UL DCI. The UL DCI is UL DCI for scheduling uplink transmission or UL DCI without uplink scheduling.

In an embodiment of this application, in a case that the target TCI state includes a plurality of joint TCI states, and the plurality of joint TCI states are associated or include an uplink power control parameter, it is determined that a TRP mode is a multi-TRP scenario; or
in a case that the target TCI state includes a plurality of separate UL TCI states, and the plurality of separate UL TCI states are associated or include an uplink power control parameter, it is determined that a TRP mode is a multi-TRP scenario; or
in a case that the target TCI state indicated by the first signaling field corresponds to more than one piece of first identifier information or second identifier information, it is determined that a TRP mode is a multi-TRP scenario.

The uplink power control parameter includes a Path Loss Reference Signal (PLRS), P0, alpha, a close loop index, and the like. In a multi-TRP scenario, the terminal transmits an uplink channel by using the target TCI state, and the network side device may schedule Physical Uplink Shared Channel (PUSCH) or PUCCHs of multi-TRPs.

In an embodiment of this application, in a case that the target TCI state includes a plurality of joint TCI states, and only one joint TCI state in the plurality of joint TCI states is associated with or includes an uplink power control parameter, it is determined that a TRP mode a single TRP scenario; or
in a case that the target TCI state includes a plurality of separate UL TCI states, and only one separate UL TCI state in the plurality of separate UL TCI states is associated with or includes an uplink power control parameter, it is determined that a TRP mode is a single TRP scenario; or
in a case that the target TCI state indicated by the first signaling field corresponds to one piece of first identifier information or second identifier information, it is determined that a TRP mode is a single TRP scenario.

In a single TRP scenario, the terminal transmits an uplink channel by using the target TCI state, and the network side device can schedule only a PUSCH or a PUCCH of a single TRP.

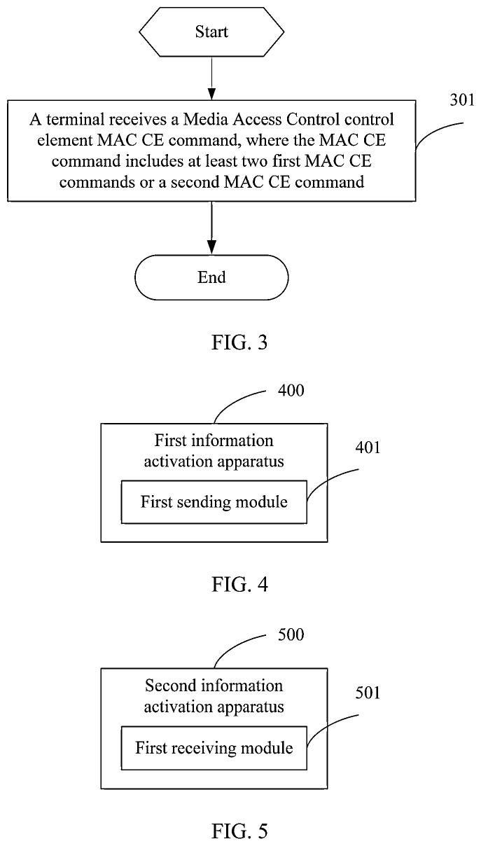

As shown in FIG. 3, an embodiment of this application provides an information activation method, including the following steps:

Step 301: A terminal receives a Media Access Control control element MAC CE command, where the MAC CE command includes at least two first MAC CE commands or a second MAC CE command.

The first MAC CE command is used to activate a transmission configuration indicator TCI state corresponding to one piece of first identifier information; the second MAC CE command is used to activate TCI states corresponding to at least two pieces of second identifier information; and the activated TCI state is used to determine common beam information of a plurality of channels.

The MAC CE command includes two cases. In one case, the MAC CE command includes at least two first MAC CE commands, and each first MAC CE command is used to activate a TCI state corresponding to one piece of first identifier information. This may be understood as a one-to-one correspondence between the first MAC CE command and the first identifier information. For example, the network side device may use a first MAC CE command corresponding to each TRP ID (that is, an RRC parameter CORESETPoolIndex) to activate a TCI state corresponding to each TRP ID. Further, the network side device further uses DCI on a PDCCH corresponding to the same TRP ID as the first MAC CE command to indicate a target TCI state corresponding to the TRP ID in TCI states activated by the first MAC CE command. In the other case, the MAC CE command includes a second MAC CE command, and the second MAC CE command is used to activate TCI states corresponding to at least two second TRP IDs. This may be understood as a one-to-many correspondence between a second MAC CE command and second TRP IDs.

In this application, the at least two first MAC CE commands may be understood as follows: One MAC CE command is sent at a time, and MAC CE commands sent for different times may have a same MAC PDU subheader that carries an eLCID, or may have different MAC PDU subheaders that carry an eLCID.

The activated TCI state includes at least one of a joint TCI state and a separate TCI state.

The activated TCI state includes a target TCI state, and the target TCI state is a TCI state used for multi-channel transmission, which may be understood as common beam information shared by a plurality of channels.

In this embodiment of this application, a terminal receives a MAC CE command, where the MAC CE command includes at least two first MAC CE commands or a second MAC CE command; the first MAC CE command is used to activate a TCI state corresponding to one piece of first identifier information; the second MAC CE command is used to activate TCI states corresponding to at least two pieces of second identifier information; and the activated TCI state is used to determine common beam information of a plurality of channels. In a multi-TRP scenario, the activated TCI state includes a TCI state that is of each TRP and that is used for multi-channel transmission, so that a same beam on each TRP can be used for multi-channel transmission in the multi-TRP scenario.

The first identifier information includes at least one of the following:
control resource set CORESET identifier information;
a CORESET pool index CORESETPoolIndex;
transmitting receiving point TRP identifier information;
channel group identifier information;
CORESET group identifier information; and
physical uplink control channel PUCCH resource group identifier information; and
the second identifier information includes at least one of the following:
CORESET identifier information;
CORESETPool Index;
TRP identifier information;
channel group identifier information;
CORESET group identifier information; and
PUCCH resource group identifier information.

In an embodiment of this application, the first MAC CE command includes a field used to indicate an identifier ID of a first TRP.

In an embodiment of this application, in a case that the network side device configures a joint TCI mode, each TCI state activated according to the first MAC CE command corresponds to one codepoint.

In an embodiment of this application, in a case that the network side device configures a separate TCI mode, each TCI state and codepoint activated according to the first MAC CE command meet one of the following:
one codepoint corresponds to one separate downlink DL TCI state and one separate uplink UL TCI state;
one codepoint corresponds to one separate DL TCI state; and
one codepoint corresponds to one separate UL TCI state.

In an embodiment of this application, each TCI state and codepoint activated according to the first MAC CE command meet one of the following:
one codepoint corresponds to one joint TCI state;
one codepoint corresponds to one separate DL TCI state and one separate UL TCI state;
one codepoint corresponds to one separate DL TCI state; and
one codepoint corresponds to one separate UL TCI state.

In an embodiment of this application, the first MAC CE command includes first indication information, and the first indication information is used to indicate that a TCI state corresponding to a codepoint is one of the following:
the joint TCI state;
the separate DL TCI state and the separate UL TCI state;
the separate DL TCI state; and
the separate UL TCI state.

In an embodiment of this application, a TCI state activated by the first MAC CE command is used for first identifier information indicated by the first MAC CE command.

In an embodiment of this application, in a case that the network side device configures a joint TCI mode, a TCI state and a codepoint activated according to the second MAC CE command meet one of the following:
one codepoint corresponds to at least two TCI states, and each TCI state in the at least two TCI states corresponds to different second identifier information; and
each codepoint corresponds to a TCI state corresponding to one piece of second identifier information, where
the TCI state corresponding to the second identifier information includes one joint TCI state.

In an embodiment of this application, in a case that the network side device configures a separate TCI mode, a TCI state and a codepoint activated according to the second MAC CE command meet one of the following:
one codepoint corresponds to TCI states corresponding to a plurality of pieces of second identifier information; and
each codepoint corresponds to a TCI state corresponding to one piece of second identifier information, where
the TCI state corresponding to the second identifier information includes at least one of one DL TCI state and one UL TCI state.

In an embodiment of this application, first target identifier information includes some second identifier information in the at least two pieces of second identifier information, and the second target identifier information is other second identifier information in the at least two pieces of second identifier information except the first target identifier information; and
in a case that the network side device configures a joint TCI mode for the first target identifier information and configures a separate TCI mode for the second target identifier information, a TCI state and a codepoint activated according to the second MAC CE command meet one of the following:
one codepoint corresponds to a TCI state corresponding to the first target identifier information and a TCI state corresponding to the second target identifier information; and
a first codepoint corresponds to the TCI state corresponding to the first target identifier information, and a second codepoint corresponds to the TCI state corresponding to the second target identifier information, where the first codepoint is a part of codepoints in codepoints activated by the second MAC CE command, and the second codepoint is a codepoint in the codepoints activated by the second MAC CE command except the first codepoint.

In an embodiment of this application, each TCI state and codepoint activated according to the second MAC CE command meet one of the following:
a TCI state corresponding to one codepoint includes a TCI state corresponding to each piece of second identifier information in the at least two pieces of second identifier information, where the TCI state of the second identifier information includes one of the following:
a joint TCI state;
a separate DL TCI state and a separate UL TCI state;
a separate DL TCI state; and
a separate UL TCI state; and
a third codepoint corresponds to a TCI state corresponding to one piece of second identifier information, and a fourth codepoint corresponds to a TCI state corresponding to another piece of second identifier information, where the third codepoint and the fourth codepoint are different codepoints in codepoints activated by the second MAC CE command, the TCI state corresponding to the one piece of second identifier information includes a joint TCI state, and the TCI state corresponding to the another piece of second identifier information includes at least one of one separate DL TCI state and one separate UL TCI state.

In an embodiment of this application, at least two of the joint TCI state, the separate DL TCI state, and the separate UL TCI state are from different TCI state pools.

In an embodiment of this application, the second MAC CE command includes second indication information, and the second indication information is used to indicate that a TCI state corresponding to a codepoint is one of the following:
the joint TCI state;
the separate DL TCI state and the separate UL TCI state;
the separate DL TCI state; and
the separate UL TCI state.

In an embodiment of this application, a correspondence between a TCI state activated by the second MAC CE command and the at least two pieces of second identifier information is determined according to one of the following:
third indication information included in the second MAC CE command, where the third indication information is used to indicate a correspondence between a codepoint and second identifier information, or is used to indicate a correspondence between a TCI state activated by the second MAC CE command and second identifier information;
an association relationship between a location or a sequence of each TCI state in a plurality of TCI states corresponding to one codepoint and each piece of second identifier information; and
an association relationship between a location or a sequence of a codepoint and each piece of second identifier information.

In an embodiment of this application, the method further includes: receiving, by the terminal, first configuration information, where the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

In an embodiment of this application, third target identifier information is the first identifier information, or the third target identifier information is any one piece of identifier information in the at least two pieces of second identifier information; and
a configuration manner of the configuration includes at least one of the following:
an association relationship is established between the third target identifier information and configuration information of the joint TCI mode;
an association relationship is established between the third target identifier information and configuration information of the separate TCI mode;
the configuration information of the joint TCI mode is included in the third target identifier information;
the configuration information of the separate TCI mode is included in the third target identifier information;
the third target identifier information is included in the configuration information of the joint TCI mode; and
the third target identifier information is included in the configuration information of the separate TCI mode.

In an embodiment of this application, the method further includes: receiving, by the terminal, target DCI, where the target DCI is used to indicate a target TCI state in the activated TCI state.

In an embodiment of this application, the target DCI is DCI transmitted on a CORESET corresponding to fourth target identifier information, and is used to indicate a target TCI state corresponding to fifth target identifier information, where
both the fourth target identifier information and the fifth target identifier information are the first identifier information, the target TCI state is at least one of TCI states activated by a first target MAC CE command, and the first target MAC CE command is a first MAC CE command corresponding to the fifth target identifier information in the at least two first MAC CE commands.

In an embodiment of this application, the target DCI is DCI transmitted on a CORESET corresponding to sixth target identifier information, and is used to indicate a target TCI state corresponding to each piece of second identifier information in the at least two pieces of second identifier information, where the sixth target identifier information is identifier information or any one piece of identifier information in the at least two pieces of second identifier information.

In an embodiment of this application, the first MAC CE command includes a first signaling field, and the first signaling field is used to indicate the target TCI state in TCI states activated by the first MAC CE command; or
the second MAC CE command includes a first signaling field, and the first signaling field is used to indicate the target TCI state in TCI states activated by the second MAC CE command; or
the target DCI includes a first signaling field, and the first signaling field is used to indicate the target TCI state in TCI states corresponding to a codepoint indicated by a TCI field of the target DCI.

In an embodiment of this application, whether the first MAC CE command includes the first signaling field is determined according to at least one of the following:
configuration information of the network side device; and
a quantity of TCI states activated by the first MAC CE command;
or
whether the second MAC CE command includes the first signaling field is determined according to at least one of the following:
configuration information of the network side device; and
a quantity of TCI states activated by the second MAC CE command;
or
whether the target DCI includes the first signaling field is determined according to at least one of the following:
configuration information of the network side device;
a quantity of TCI states activated by the first MAC CE command;
a quantity of TCI states activated by the second MAC CE command; and
a quantity of TCI states corresponding to the codepoint indicated by the TCI field of the target DCI.

In an embodiment of this application, the first signaling field is used to indicate one of the following:
one joint TCI state, or one pair of separate TCI states, or one separate UL TCI state, or one separate DL TCI state in the TCI states activated by the first MAC CE command;
all TCI states activated by the first MAC CE command; and
all TCI states activated by the first MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states activated by the second MAC CE command;
all TCI states activated by the second MAC CE command; and
all TCI states activated by the second MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states corresponding to the codepoint indicated by the TCI field of the target DCI;
all TCI states corresponding to the codepoint indicated by the TCI field of the target DCI; and
all TCI states corresponding to the codepoint indicated by the TCI field of the target DCI, and a sequence or a location of each TCI state.

In an embodiment of this application, the target DCI is UL DCI. The first signaling field is a sounding reference signal SRS resource set indicator field in the UL DCI. The UL DCI is UL DCI for scheduling uplink transmission or UL DCI without uplink scheduling.

In an embodiment of this application, in a case that the target TCI state includes a plurality of joint TCI states, and the plurality of joint TCI states are associated or include an uplink power control parameter, it is determined that a TRP mode is a multi-TRP scenario; or
in a case that the target TCI state includes a plurality of separate UL TCI states, and the plurality of separate UL TCI states are associated or include an uplink power control parameter, it is determined that a TRP mode is a multi-TRP scenario; or
in a case that the target TCI state indicated by the first signaling field corresponds to more than one piece of first identifier information or second identifier information, it is determined that a TRP mode is a multi-TRP scenario.

In an embodiment of this application, in a case that the target TCI state includes a plurality of joint TCI states, and only one joint TCI state in the plurality of joint TCI states is associated with or includes an uplink power control parameter, it is determined that a TRP mode a single TRP scenario; or
in a case that the target TCI state includes a plurality of separate UL TCI states, and only one separate UL TCI state in the plurality of separate UL TCI states is associated with or includes an uplink power control parameter, it is determined that a TRP mode is a single TRP scenario; or
in a case that the target TCI state indicated by the first signaling field corresponds to one piece of first identifier information or second identifier information, it is determined that a TRP mode is a single TRP scenario.

The information activation method performed by the terminal has a same technical feature as the information activation method performed by the network side device. For details, refer to the embodiment on the network side device side. Details are not described herein again.

The following uses an example in which the first identifier information or the second identifier information includes a TRP ID (for example, CORESETPoolIndex) to describe the information activation method provided in this application.

Activation manner 1: The network side device activates a TCI state corresponding to each TRP ID by using a MAC CE corresponding to each TRP ID, that is, there is a one-to-one correspondence between a MAC CE and a TRP.

The network side device further uses DCI on a PDCCH corresponding to a same TRP ID as a MAC CE and a TCI field of the DCI to indicate, a TCI state corresponding to the TRP ID in TCI states activated by the MAC CE.
(1) The network side device activates a TCI state corresponding to a first TRP ID (for example, a CORESETPoolIndex value 0) by using one MAC CE, and the network side device activates a TCI state corresponding to a second TRP ID (for example, a CORESETPoolIndex value 1) by using another MAC CE.
(2) The MAC CE command includes a field that represents the TRP ID, such as a field that indicates CORESETPoolIndex.
(3) When the network side device configures a joint TCI mode (joint TCI) or a separate TCI mode (separate TCI) (for each CORESETPoolIndex) by using RRC signaling:
(31) For the joint TCI mode, one TCI state in TCI states activated by a MAC CE corresponds to one codepoint, and the activated TCI state is used for a TRP ID indicated by the MAC CE.

(32) For the separate TCI mode, in TCI states activated by a MAC CE, one codepoint may correspond to one DL TCI state and one UL TCI state, or one DL TCI state, or one UL TCI state, and the activated TCI state is used for a TRP ID indicated by the MAC CE.
(4) In a case that the network side device does not explicitly configures a joint TCI mode (joint TCI) or a separate TCI mode (separate TCI) (for each CORESETPoolIndex):

In TCI states activated by a MAC CE, one codepoint may correspond to one joint TCI state, or one separate DL TCI state and one separate UL TCI state, or one separate DL TCI state, or one separate UL TCI state.

A manner of distinguishing whether a TCI state corresponding to a codepoint is joint or separate is: distinguishing joint, separate DL, or separate UL according to TCI states are from different TCI state pools, and/or adding indication information to a MAC CE to indicate whether a TCI state corresponding to ae codepoint is joint TCI or separate TCI.

Activation manner 2: The network side device activates TCI states corresponding to all TRP IDs by using a MAC CE corresponding to all the TRP IDs (for example, CORESETPoolIndex), and there is a one-to-many correspondence between a MAC CE and TRPs.
(1) In a case that the network side device configures joint TCI or separate TCI by using RRC signaling:
(11) Joint TCI is uniformly configured for all TRPs (all CORESETPoolIndex). In TCI states activated by a MAC CE, a TCI state corresponding to one codepoint corresponds to each TRP, or each codepoint corresponds to different TRPs.
(a) For example, a TCI state 1 corresponding to a codepoint 1 is used as a joint TCI state corresponding to a TRP 1, and a TCI state 2 corresponding to the codepoint 1 is used as a joint TCI state corresponding to a TRP 2.
(b) For example, a TCI state corresponding to a codepoint 1 is used as a joint TCI state corresponding to a TRP 1, and a TCI state corresponding to a codepoint 2 is used as a joint TCI state corresponding to a TRP 2.
(12) Separate TCI is uniformly configured for all TRPs (all CORESETPoolIndex). In TCI states activated by a MAC CE, a TCI state corresponding to one codepoint may include one DL TCI state and one UL TCI state, or one DL TCI state, or one UL TCI state of each TRP in multi-TRPs, or each codepoint corresponds to different TRPs.
(a) For example, a TCI state 1 and a TCI state 2 corresponding to a codepoint 1 are used as a separate DL TCI state and a separate UL TCI state corresponding to a TRP 1, and a TCI state 3 and a TCI state 4 corresponding to the codepoint 1 are used as a separate DL TCI state and a separate UL TCI state corresponding to a TRP 2.
(b) For example, two TCI states corresponding to a codepoint 1 are used as a separate DL TCI state and a separate UL TCI state corresponding to a TRP 1, and two TCI states corresponding to a codepoint 2 are used as a separate DL TCI state and a separate UL TCI state corresponding to a TRP 2.
(13) Joint TCI is configured for a part of TRPs (a part of CORESETPoolIndex) and separate TCI is configured for another part of TRPs (another part of CORESETPoolIndex). In TCI states activated by a MAC CE, one codepoint may correspond to a joint TCI state of a part of TRPs and a separate TCI state of another part of TRPs; or some codepoints correspond to a joint TCI state od a part of TRPs and some codepoints correspond to a separate TCI state of another part of TRPs.
(2) In a case that the network side device does not explicitly configure joint TCI or separate TCI:

In TCI states activated by a MAC CE, a TCI state corresponding to one codepoint may include a TCI state (which may be joint or separate, but it is not mandatory to be joint or separate) of each TRP (each CORESETPoolIndex) in all TRPs (all CORESETPoolIndex). In some alternative embodiments, some codepoints correspond to a joint TCI state of one TRP and some codepoints correspond to a separate TCI state of one TRP. A manner of distinguishing whether a TCI state corresponding to a codepoint is joint or separate is the same as above.

In the foregoing, a correspondence between a TCI state or a codepoint and a TRP (CORESETPoolIndex) may be determined according to indication information in the MAC CE, or an association is established with a TRP ID (CORESETPoolIndex) according to a location or a sequence of a TCI state in TCI states corresponding to one codepoint, or an association is established with a TRP ID (CORESETPoolIndex) according to a location or a sequence of a codepoint.

Each activated TCI state may have a default TCI state. In this case, the default TCI state is the same as the last activated TCI state.

When the network side device configures joint TCI or separate TCI of each TRP by using RRC signaling:
i. The network side device uniformly configures joint TCI or separate TCI for all TRPs, that is, all the TRPs share one piece of configuration information.
ii. In some alternative embodiments, the network side device separately configures joint TCI or separate TCI for each TRP, that is, each TRP has one piece of configuration information. For example, an association is established between TRP ID information (CORESETPoolIndex) and configuration information of joint TCI and separate TCI (joint TCI and separate TCI modes), or one piece of information includes another piece of information.

The network side device indicates, by using DCI, a TCI state in TCI state activated by a MAC CE. For a multi-TRP scenario, the DCI meets the following:
1. In the activation manner 1, for DCI transmitted on a CORESET corresponding to a TRP ID 1, a TCI field in the DCI is used to indicate a TCI state activated by a MAC CE corresponding to the TRP ID 1. For DCI transmitted on a CORESET corresponding to a TRP ID 2, a TCI field in the DCI is used to indicate a TCI state activated by a MAC CE corresponding to the TRP ID 2.
2. In the activation manner 2, DCI may be transmitted by using a PDCCH on a CORESET corresponding to a TRP ID or any TRP ID, and is used to indicate a TCI state activated by a MAC CE corresponding to any TRP ID or all TRP IDs.

Further, a first signaling field is introduced into the DCI, and the first signaling field is used to indicate at least one of the following:
i. One joint TCI state or one pair of separate TCI states in a TCI state corresponding to a codepoint indicated by a TCI field.
ii. All TCI states corresponding to the codepoint indicated by the TCI field.
iii. All TCI states corresponding to the codepoint indicated by the TCI field and sequences or locations thereof.

Whether the first signaling field presents or is ignored is determined according to one of the following:
a configuration of the network side device;
if a MAC CE activates one joint TCI state or one pair of separate TCI states, the network side device configures that no first signaling field presents in the DCI; and
if a MAC CE activates one joint TCI state or one pair of separate TCI states, UE ignores or does not interpret the first signaling field (even if present).

Further, first DCI is UL DCI, and is used to indicate a TCI state in TCI states activated by the MAC CE.

An SRS resource set indicator field in the UL DCI is reused, and a feature of the field is described as same as the first signaling field.

The first DCI may be UL DCI for scheduling uplink transmission, or may be UL DCI without uplink scheduling.

In some embodiments, a TRP mode is determined according to a quantity of TCI states that are in TCI states indicated by the network side device and that are associated with or include a PC parameter (at least one of a PLRS and setting {P0, alpha, closeloopindex}):
(1) If the network side device indicates a plurality of joint TCI states or separate UL TCI states, and these TCI states are associated or include a PC parameter:
i. A quantity of TRPs (single TRP (single TRP) or multi-TRP (multi-TRP)) corresponding to UL transmission may be dynamically indicated by a first signaling field in UL DCI. If the first signaling field indicates one TCI state, a single TRP scenario is determined. If the first signaling field indicates a plurality of TCI states, a multi-TRP scenario is determined.
ii. In some alternative embodiments, it is considered that this is a multi-TRP scenario in this case, and UE transmits an uplink channel by using the plurality of TCI states (the network side device may schedule PUSCHs or PUCCHs of multi-TRPs).
(2) If the network side device indicates a plurality of joint TCI states or separate UL TCI states, and only one TCI state is associated with or includes a PC parameter, it is considered that this is a single TRP scenario in this case, and UE transmits an uplink channel by using the TCI state (the network side device can only schedule a PUSCH or a PUCCH of a single TRP).

The information activation method in this application can implement a solution of applying a unified TCI framework in a multi-TRP scenario. By activating and indicating a unified TCI state, the network may implement a multi-TRP common beam in single DCI and multi-DCI scenarios. In addition, the beam indication solution may further support switching between a single TRP scenario and a multi-TRP scenario and selection of a TRP, and may fully and flexibly support a unified TCI solution in a multi-TRP scenario.

The information activation method provided in the embodiments of this application may be performed by an information activation apparatus. In the embodiments of this application, an example in which the information activation apparatus performs the information activation method is used to describe the information activation apparatus provided in the embodiments of this application.

As shown in FIG. 4, an embodiment of this application provides an information activation apparatus. A first information activation apparatus 400 includes:
a first sending module 401, configured to send a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

Further, the first MAC CE command includes a field used to indicate an identifier ID of the first identifier information.

Further, in a case that the network side device configures a joint TCI mode, each TCI state activated according to the first MAC CE command corresponds to one codepoint.

Further, in a case that the network side device configures a separate TCI mode, each TCI state and codepoint activated according to the first MAC CE command meet one of the following:
one codepoint corresponds to one separate downlink DL TCI state and one separate uplink UL TCI state;
one codepoint corresponds to one separate DL TCI state; and
one codepoint corresponds to one separate UL TCI state.

Further, each TCI state and codepoint activated according to the first MAC CE command meet one of the following:
one codepoint corresponds to one joint TCI state;
one codepoint corresponds to one separate DL TCI state and one separate UL TCI state;
one codepoint corresponds to one separate DL TCI state; and
one codepoint corresponds to one separate UL TCI state.

Further, the first MAC CE command includes first indication information, and the first indication information is used to indicate that a TCI state corresponding to a codepoint is one of the following:
the joint TCI state;
the separate DL TCI state and the separate UL TCI state;
the separate DL TCI state; and
the separate UL TCI state.

Further, a TCI state activated by the first MAC CE command is used for first identifier information indicated by the first MAC CE command.

Further, in a case that the network side device configures a joint TCI mode for the at least two pieces of second identifier information, a TCI state and a codepoint activated according to the second MAC CE command meet one of the following:
one codepoint corresponds to at least two TCI states, and each TCI state in the at least two TCI states corresponds to different second identifier information; and
each codepoint corresponds to a TCI state corresponding to one piece of second identifier information, where
the TCI state corresponding to the second identifier information includes one joint TCI state.

Further, in a case that the network side device configures a separate TCI mode, a TCI state and a codepoint activated according to the second MAC CE command meet one of the following:
one codepoint corresponds to TCI states of a plurality of pieces of second identifier information in the at least two pieces of second identifier information; and
each codepoint corresponds to a TCI state of one piece of second identifier information, where
the TCI state corresponding to the second identifier information includes at least one of one DL TCI state and one UL TCI state.

Further, first target identifier information includes a part of second identifier information in the at least two pieces of second identifier information, and the second target identifier information is other second identifier information in the at least two pieces of second identifier information except the first target identifier information; and
in a case that the network side device configures a joint TCI mode for the first target identifier information and configures a separate TCI mode for the second target identifier information, a TCI state and a codepoint activated according to the second MAC CE command meet one of the following:
one codepoint corresponds to a TCI state corresponding to the first target identifier information and a TCI state of second identifier information in the second target identifier information; and
a first codepoint corresponds to the TCI state corresponding to the first target identifier information, and a second codepoint corresponds to the TCI state corresponding to the second target identifier information, where the first codepoint is a part of codepoints in codepoints activated by the second MAC CE command, and the second codepoint is a codepoint in the codepoints activated by the second MAC CE command except the first codepoint.

Further, each TCI state and codepoint activated according to the second MAC CE command meet one of the following:
a TCI state corresponding to one codepoint includes a TCI state corresponding to each piece of second identifier information in the at least two pieces of second identifier information, where the TCI state of the second identifier information includes one of the following:
a joint TCI state;
a separate DL TCI state and a separate UL TCI state;
a separate DL TCI state; and
a separate UL TCI state; and
a third codepoint corresponds to a TCI state corresponding to one piece of second identifier information, and a fourth codepoint corresponds to a TCI state corresponding to another piece of second identifier information, where the third codepoint and the fourth codepoint are different codepoints in codepoints activated by the second MAC CE command, the TCI state corresponding to the one piece of second identifier information includes a joint TCI state, and the TCI state corresponding to the another piece of second identifier information includes at least one of one separate DL TCI state and one separate UL TCI state.

Further, at least two of the joint TCI state, the separate DL TCI state, and the separate UL TCI state are from different TCI state pools.

Further, the second MAC CE command includes second indication information, and the second indication information is used to indicate that a TCI state corresponding to a codepoint is one of the following:
the joint TCI state;
the separate DL TCI state and the separate UL TCI state;
the separate DL TCI state; and
the separate UL TCI state.

Further, a correspondence between a TCI state activated by the second MAC CE command and the at least two pieces of second identifier information is determined according to one of the following:
third indication information included in the second MAC CE command, where the third indication information is used to indicate a correspondence between a codepoint and second identifier information, or is used to indicate a correspondence between a TCI state activated by the second MAC CE command and second identifier information;
an association relationship between a location or a sequence of each TCI state in a plurality of TCI states corresponding to one codepoint and each piece of second identifier information; and
an association relationship between a location or a sequence of a codepoint and each piece of second identifier information.

Further, the apparatus 400 further includes a second sending module, configured to send first configuration information, where the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

Further, third target identifier information is the first identifier information, or the third target identifier information is any one piece of identifier information in the at least two pieces of second identifier information; and
a configuration manner of the configuration includes at least one of the following:
an association relationship is established between the third target identifier information and configuration information of the joint TCI mode;
an association relationship is established between the third target identifier information and configuration information of the separate TCI mode;
the configuration information of the joint TCI mode is included in the third target identifier information;
the configuration information of the separate TCI mode is included in the third target identifier information;
the third target identifier information is included in the configuration information of the joint TCI mode; and
the third target identifier information is included in the configuration information of the separate TCI mode.

Further, the apparatus 400 further includes a third sending module, configured to send target DCI, where the target DCI is used to indicate a target TCI state in the activated TCI states.

Further, the target DCI is DCI transmitted on a CORESET corresponding to fourth target identifier information, and is used to indicate a target TCI state corresponding to fifth target identifier information, where
both the fourth target identifier information and the fifth target identifier information are the first identifier information, the target TCI state is at least one of TCI states activated by a first target MAC CE command, and the first target MAC CE command is a first MAC CE command corresponding to the fifth target identifier information in the at least two first MAC CE commands.

Further, the target DCI is DCI transmitted on a CORESET corresponding to sixth target identifier information, and is used to indicate a target TCI state corresponding to each piece of second identifier information in the at least two pieces of second identifier information, where the sixth target identifier information is identifier information or any one piece of identifier information in the at least two pieces of second identifier information.

Further, the first MAC CE command includes a first signaling field, and the first signaling field is used to indicate the target TCI state in TCI states activated by the first MAC CE command; or
the second MAC CE command includes a first signaling field, and the first signaling field is used to indicate the target TCI state in TCI states activated by the second MAC CE command; or
the target DCI includes a first signaling field, and the first signaling field is used to indicate the target TCI state in TCI states corresponding to a codepoint indicated by a TCI field of the target DCI.

Further, whether the first MAC CE command includes the first signaling field is determined according to at least one of the following:
configuration information of the network side device; and
a quantity of TCI states activated by the first MAC CE command;
or
whether the second MAC CE command includes the first signaling field is determined according to at least one of the following:
configuration information of the network side device; and
a quantity of TCI states activated by the second MAC CE command;
or
whether the target DCI includes the first signaling field is determined according to at least one of the following:
configuration information of the network side device;
a quantity of TCI states activated by the first MAC CE command;
a quantity of TCI states activated by the second MAC CE command; and
a quantity of TCI states corresponding to the codepoint indicated by the TCI field of the target DCI.

Further, the first signaling field is used to indicate one of the following:
one joint TCI state, or one pair of separate TCI states, or one separate UL TCI state, or one separate DL TCI state in the TCI states activated by the first MAC CE command;
all TCI states activated by the first MAC CE command; and
all TCI states activated by the first MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states activated by the second MAC CE command;
all TCI states activated by the second MAC CE command; and
all TCI states activated by the second MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states corresponding to the codepoint indicated by the TCI field of the target DCI;
all TCI states corresponding to the codepoint indicated by the TCI field of the target DCI; and
all TCI states corresponding to the codepoint indicated by the TCI field of the target DCI, and a sequence or a location of each TCI state.

Further, the target DCI is UL DCI.

Further, the first signaling field is a sounding reference signal SRS resource set indicator field in the UL DCI.

Further, the UL DCI is UL DCI for scheduling uplink transmission or UL DCI without uplink scheduling.

Further, in a case that the target TCI state includes a plurality of joint TCI states, and the plurality of joint TCI states are associated or include an uplink power control parameter, it is determined that a TRP mode is a multi-TRP scenario; or
in a case that the target TCI state includes a plurality of separate UL TCI states, and the plurality of separate UL TCI states are associated or include an uplink power control parameter, it is determined that a TRP mode is a multi-TRP scenario; or
in a case that the target TCI state indicated by the first signaling field corresponds to more than one piece of first identifier information or second identifier information, it is determined that a TRP mode is a multi-TRP scenario.

Further, in a case that the target TCI state includes a plurality of joint TCI states, and only one joint TCI state in the plurality of joint TCI states is associated with or includes an uplink power control parameter, it is determined that a TRP mode a single TRP scenario; or
in a case that the target TCI state includes a plurality of separate UL TCI states, and only one separate UL TCI state in the plurality of separate UL TCI states is associated with or includes an uplink power control parameter, it is determined that a TRP mode is a single TRP scenario; or
in a case that the target TCI state indicated by the first signaling field corresponds to one piece of first identifier information or second identifier information, it is determined that a TRP mode is a single TRP scenario.

The first information activation apparatus 400 provided in this embodiment of this application can implement the processes implemented in the method embodiment in FIG. 2, and achieve a same technical effect. To avoid repetition, details are not described herein again.

As shown in FIG. 5, an embodiment of this application provides an information activation apparatus. A second information activation apparatus 500 includes:
a first receiving module 501, configured to receive a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

Further, the first identifier information includes at least one of the following:
control resource set CORESET identifier information;
a CORESET pool index CORESETPoolIndex;
transmitting receiving point TRP identifier information;
channel group identifier information;
CORESET group identifier information; and
physical uplink control channel PUCCH resource group identifier information; and
the second identifier information includes at least one of the following:
CORESET identifier information;
CORESETPoolIndex;
TRP identifier information;
channel group identifier information;
CORESET group identifier information; and
PUCCH resource group identifier information.

Further, in a case that the network side device configures a joint TCI mode, each TCI state activated according to the first MAC CE command corresponds to one codepoint.

Further, in a case that the network side device configures a separate TCI mode, each TCI state and codepoint activated according to the first MAC CE command meet one of the following:
one codepoint corresponds to one separate downlink DL TCI state and one separate uplink UL TCI state;
one codepoint corresponds to one separate DL TCI state; and
one codepoint corresponds to one separate UL TCI state.

Further, each TCI state and codepoint activated according to the first MAC CE command meet one of the following:
one codepoint corresponds to one joint TCI state;
one codepoint corresponds to one separate DL TCI state and one separate UL TCI state;
one codepoint corresponds to one separate DL TCI state; and
one codepoint corresponds to one separate UL TCI state.

Further, the first MAC CE command includes first indication information, and the first indication information is used to indicate that a TCI state corresponding to a codepoint is one of the following:
the joint TCI state;
the separate DL TCI state and the separate UL TCI state;
the separate DL TCI state; and
the separate UL TCI state.

Further, a TCI state activated by the first MAC CE command is used for first identifier information indicated by the first MAC CE command.

Further, in a case that the network side device configures a joint TCI mode, a TCI state and a codepoint activated according to the second MAC CE command meet one of the following:
one codepoint corresponds to at least two TCI states, and each TCI state in the at least two TCI states corresponds to different second identifier information; and
each codepoint corresponds to a TCI state corresponding to one piece of second identifier information, where
the TCI state corresponding to the second identifier information includes one joint TCI state.

Further, in a case that the network side device configures a separate TCI mode for the at least two pieces of second identifier information, a TCI state and a codepoint activated according to the second MAC CE command meet one of the following:
one codepoint corresponds to TCI states corresponding to a plurality of pieces of second identifier information in the at least two pieces of second identifier information; and
each codepoint corresponds to a TCI state corresponding to one piece of second identifier information, where
the TCI state corresponding to the second identifier information includes at least one of one DL TCI state and one UL TCI state.

Further, first target identifier information includes a part of second identifier information in the at least two pieces of second identifier information, and the second target identifier information is other second identifier information in the at least two pieces of second identifier information except the first target identifier information; and
in a case that the network side device configures a joint TCI mode for the first target identifier information and configures a separate TCI mode for the second target identifier information, a TCI state and a codepoint activated according to the second MAC CE command meet one of the following:
one codepoint corresponds to a TCI state corresponding to the first target identifier information and a TCI state of second identifier information in the second target identifier information; and
a first codepoint corresponds to the TCI state corresponding to the first target identifier information, and a second codepoint corresponds to the TCI state corresponding to the second target identifier information, where the first codepoint is a part of codepoints in codepoints activated by the second MAC CE command, and the second codepoint is a codepoint in the codepoints activated by the second MAC CE command except the first codepoint.

Further, each TCI state and codepoint activated according to the second MAC CE command meet one of the following:
a TCI state corresponding to one codepoint includes a TCI state corresponding to each piece of second identifier information in the at least two pieces of second identifier information, where the TCI state of the second identifier information includes one of the following:
a joint TCI state;
a separate DL TCI state and a separate UL TCI state;
a separate DL TCI state; and
a separate UL TCI state; and
a third codepoint corresponds to a TCI state corresponding to one piece of second identifier information, and a fourth codepoint corresponds to a TCI state corresponding to another piece of second identifier information, where the third codepoint and the fourth codepoint are different codepoints in codepoints activated by the second MAC CE command, the TCI state corresponding to the one piece of second identifier information includes a joint TCI state, and the TCI state corresponding to the another piece of second identifier information includes at least one of one separate DL TCI state and one separate UL TCI state.

Further, at least two of the joint TCI state, the separate DL TCI state, and the separate UL TCI state are from different TCI state pools.

Further, the second MAC CE command includes second indication information, and the second indication information is used to indicate that a TCI state corresponding to a codepoint is one of the following:
the joint TCI state;
the separate DL TCI state and the separate UL TCI state;
the separate DL TCI state; and
the separate UL TCI state.

Further, a correspondence between a TCI state activated by the second MAC CE command and the at least two pieces of second identifier information is determined according to one of the following:
third indication information included in the second MAC CE command, where the third indication information is used to indicate a correspondence between a codepoint and second identifier information, or is used to indicate a correspondence between a TCI state activated by the second MAC CE command and second identifier information;
an association relationship between a location or a sequence of each TCI state in a plurality of TCI states corresponding to one codepoint and each piece of second identifier information; and
an association relationship between a location or a sequence of a codepoint and each piece of second identifier information.

Further, the apparatus 500 further includes a second receiving module, configured to receive first configuration information, where the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

Further, third target identifier information is the first identifier information, or the third target identifier information is any one piece of identifier information in the at least two pieces of second identifier information; and
a configuration manner of the configuration includes at least one of the following:
an association relationship is established between the third target identifier information and configuration information of the joint TCI mode;
an association relationship is established between the third target identifier information and configuration information of the separate TCI mode;
the configuration information of the joint TCI mode is included in the third target identifier information;
the configuration information of the separate TCI mode is included in the third target identifier information;
the third target identifier information is included in the configuration information of the joint TCI mode; and
the third target identifier information is included in the configuration information of the separate TCI mode.

Further, the apparatus 500 further includes a third receiving module, configured to receive target DCI, where the target DCI is used to indicate a target TCI state in the activated TCI states.

Further, the target DCI is DCI transmitted on a CORESET corresponding to fourth target identifier information, and is used to indicate a target TCI state corresponding to fifth target identifier information, where
both the fourth target identifier information and the fifth target identifier information are the first identifier information, the target TCI state is at least one of TCI states activated by a first target MAC CE command, and the first target MAC CE command is a first MAC CE command corresponding to the fifth target identifier information in the at least two first MAC CE commands.

Further, the target DCI is DCI transmitted on a CORESET corresponding to sixth target identifier information, and is used to indicate a target TCI state corresponding to each piece of second identifier information in the at least two pieces of second identifier information, where the sixth target identifier information is identifier information or any one piece of identifier information in the at least two pieces of second identifier information.

Further, the first MAC CE command includes a first signaling field, and the first signaling field is used to indicate the target TCI state in TCI states activated by the first MAC CE command; or
the second MAC CE command includes a first signaling field, and the first signaling field is used to indicate the target TCI state in TCI states activated by the second MAC CE command; or
the target DCI includes a first signaling field, and the first signaling field is used to indicate the target TCI state in TCI states corresponding to a codepoint indicated by a TCI field of the target DCI.

Further, whether the first MAC CE command includes the first signaling field is determined according to at least one of the following:
configuration information of the network side device; and
a quantity of TCI states activated by the first MAC CE command;
or
whether the second MAC CE command includes the first signaling field is determined according to at least one of the following:
configuration information of the network side device; and
a quantity of TCI states activated by the second MAC CE command;
or
whether the target DCI includes the first signaling field is determined according to at least one of the following:
configuration information of the network side device;
a quantity of TCI states activated by the first MAC CE command;
a quantity of TCI states activated by the second MAC CE command; and
a quantity of TCI states corresponding to the codepoint indicated by the TCI field of the target DCI.

Further, the first signaling field is used to indicate one of the following:
one joint TCI state, or one pair of separate TCI states, or one separate UL TCI state, or one separate DL TCI state in the TCI states activated by the first MAC CE command;
all TCI states activated by the first MAC CE command; and
all TCI states activated by the first MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states activated by the second MAC CE command;
all TCI states activated by the second MAC CE command; and
all TCI states activated by the second MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states corresponding to the codepoint indicated by the TCI field of the target DCI;
all TCI states corresponding to the codepoint indicated by the TCI field of the target DCI; and
all TCI states corresponding to the codepoint indicated by the TCI field of the target DCI, and a sequence or a location of each TCI state.

Further, the target DCI is UL DCI.

Further, the first signaling field is a sounding reference signal SRS resource set indicator field in the UL DCI.

Further, the UL DCI is UL DCI for scheduling uplink transmission or UL DCI without uplink scheduling.

Further, in a case that the target TCI state includes a plurality of joint TCI states, and the plurality of joint TCI states are associated or include an uplink power control parameter, it is determined that a TRP mode is a multi-TRP scenario; or
in a case that the target TCI state includes a plurality of separate UL TCI states, and the plurality of separate UL TCI states are associated or include an uplink power control parameter, it is determined that a TRP mode is a multi-TRP scenario; or
in a case that the target TCI state indicated by the first signaling field corresponds to more than one piece of first identifier information or second identifier information, it is determined that a TRP mode is a multi-TRP scenario.

Further, in a case that the target TCI state includes a plurality of joint TCI states, and only one joint TCI state in the plurality of joint TCI states is associated with or includes an uplink power control parameter, it is determined that a TRP mode a single TRP scenario; or
in a case that the target TCI state includes a plurality of separate UL TCI states, and only one separate UL TCI state in the plurality of separate UL TCI states is associated with or includes an uplink power control parameter, it is determined that a TRP mode is a single TRP scenario; or
in a case that the target TCI state indicated by the first signaling field corresponds to one piece of first identifier information or second identifier information, it is determined that a TRP mode is a single TRP scenario.

The second information activation apparatus 500 provided in this embodiment of this application can implement the processes implemented in the method embodiment in FIG. 3, and achieve a same technical effect. To avoid repetition, details are not described herein again.

The second information activation apparatus 500 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a Network Attached Storage (NAS), or the like. This is not specifically limited in this embodiment of this application.

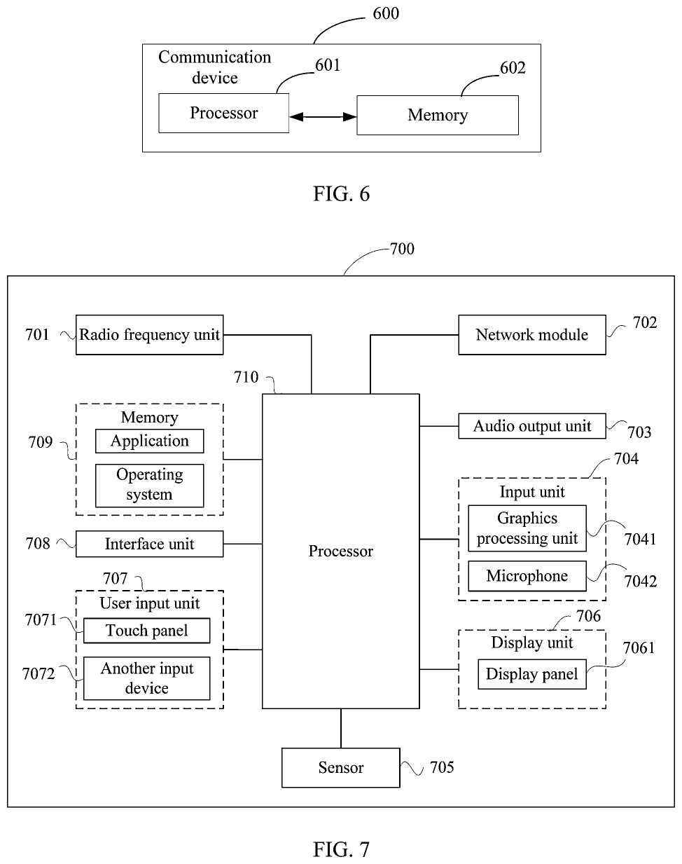

For example, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing information activation method embodiment shown in FIG. 3, and a same technical effect can be achieved. When the communication device 600 is a network side device, the program or the instruction is executed by the processor 601 to implement the steps of the foregoing information activation method embodiment shown in FIG. 2, and a same technical effect can be achieved. To avoid repetition, details are not described herein again.

An embodiment of this application further provides a terminal, including a processor and a communication interface. The communication interface is configured to receive a Media Access Control control element MAC CE command, where the MAC CE command includes at least two first MAC CE commands or a second MAC CE command; the first MAC CE command is used to activate a transmission configuration indicator TCI state corresponding to one piece of first identifier information; the second MAC CE command is used to activate TCI states corresponding to at least two pieces of second identifier information; and the activated TCI state is used to determine common beam information of a plurality of channels. This terminal embodiment corresponds to the foregoing method embodiment on the terminal side. Each implementation process and implementation of the foregoing method embodiment may be applicable to this terminal embodiment, and a same technical effect can be achieved. For example, FIG. 7 is a schematic diagram of a hardware structure of a terminal according to an embodiment of this application.

A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments, an application processor and a modem processor are integrated into the processor 710. The application processor mainly processes an operating system, a user interface, an application, and the like. The modem processor mainly processes a wireless communication signal, for example, a baseband processor. It can be understood that the modem processor may not be integrated into the processor 710.

The radio frequency unit 701 is configured to receive a Media Access Control control element MAC CE command, where the MAC CE command includes at least two first MAC CE commands or a second MAC CE command;
the first MAC CE command is used to activate a transmission configuration indicator TCI state corresponding to one piece of first identifier information;
the second MAC CE command is used to activate TCI states corresponding to at least two pieces of second identifier information; and
the activated TCI state is used to determine common beam information of a plurality of channels.

Further, the first identifier information includes at least one of the following:
control resource set CORESET identifier information;
a CORESET pool index CORESETPoolIndex;
transmitting receiving point TRP identifier information;
channel group identifier information;
CORESET group identifier information; and
physical uplink control channel PUCCH resource group identifier information; and
the second identifier information includes at least one of the following:
CORESET identifier information;
CORESETPoolIndex;
TRP identifier information;
channel group identifier information;
CORESET group identifier information; and
PUCCH resource group identifier information.

Further, in a case that the network side device configures a joint TCI mode, each TCI state activated according to the first MAC CE command corresponds to one codepoint.

Further, in a case that the network side device configures a separate TCI mode, each TCI state and codepoint activated according to the first MAC CE command meet one of the following:
one codepoint corresponds to one separate downlink DL TCI state and one separate uplink UL TCI state;
one codepoint corresponds to one separate DL TCI state; and
one codepoint corresponds to one separate UL TCI state.

Further, each TCI state and codepoint activated according to the first MAC CE command meet one of the following:
one codepoint corresponds to one joint TCI state;
one codepoint corresponds to one separate DL TCI state and one separate UL TCI state;
one codepoint corresponds to one separate DL TCI state; and
one codepoint corresponds to one separate UL TCI state.

Further, the first MAC CE command includes first indication information, and the first indication information is used to indicate that a TCI state corresponding to a codepoint is one of the following:
the joint TCI state;
the separate DL TCI state and the separate UL TCI state;
the separate DL TCI state; and
the separate UL TCI state.

Further, a TCI state activated by the first MAC CE command is used for first identifier information indicated by the first MAC CE command.

Further, in a case that the network side device configures a joint TCI mode, a TCI state and a codepoint activated according to the second MAC CE command meet one of the following:
one codepoint corresponds to at least two TCI states, and each TCI state in the at least two TCI states corresponds to different second identifier information; and
each codepoint corresponds to a TCI state corresponding to one piece of second identifier information, where
the TCI state corresponding to the second identifier information includes one joint TCI state.

Further, in a case that the network side device configures a separate TCI mode, a TCI state and a codepoint activated according to the second MAC CE command meet one of the following:
one codepoint corresponds to TCI states corresponding to a plurality of pieces of second identifier information in the at least two pieces of second identifier information; and
each codepoint corresponds to a TCI state corresponding to one piece of second identifier information, where
the TCI state corresponding to the second identifier information includes at least one of one DL TCI state and one UL TCI state.

Further, first target identifier information includes a part of second identifier information in the at least two pieces of second identifier information, and the second target identifier information is other second identifier information in the at least two pieces of second identifier information except the first target identifier information; and
in a case that the network side device configures a joint TCI mode for the first target identifier information and configures a separate TCI mode for the second target identifier information, a TCI state and a codepoint activated according to the second MAC CE command meet one of the following:
one codepoint corresponds to a TCI state corresponding to the first target identifier information and a TCI state corresponding to the second target identifier information; and
a first codepoint corresponds to the TCI state corresponding to the first target identifier information, and a second codepoint corresponds to the TCI state corresponding to the second target identifier information, where the first codepoint is a part of codepoints in codepoints activated by the second MAC CE command, and the second codepoint is a codepoint in the codepoints activated by the second MAC CE command except the first codepoint.

Further, each TCI state and codepoint activated according to the second MAC CE command meet one of the following:
a TCI state corresponding to one codepoint includes a TCI state corresponding to each piece of second identifier information in the at least two pieces of second identifier information, where the TCI state of the second identifier information includes one of the following:
a joint TCI state;
a separate DL TCI state and a separate UL TCI state;
a separate DL TCI state; and
a separate UL TCI state; and
a third codepoint corresponds to a TCI state corresponding to one piece of second identifier information, and a fourth codepoint corresponds to a TCI state corresponding to another piece of second identifier information, where the third codepoint and the fourth codepoint are different codepoints in codepoints activated by the second MAC CE command, the TCI state corresponding to the one piece of second identifier information includes a joint TCI state, and the TCI state corresponding to the another piece of second identifier information includes at least one of one separate DL TCI state and one separate UL TCI state.

Further, at least two of the joint TCI state, the separate DL TCI state, and the separate UL TCI state are from different TCI state pools.

Further, the second MAC CE command includes second indication information, and the second indication information is used to indicate that a TCI state corresponding to a codepoint is one of the following:
the joint TCI state;
the separate DL TCI state and the separate UL TCI state;
the separate DL TCI state; and
the separate UL TCI state.

Further, a correspondence between a TCI state activated by the second MAC CE command and the at least two pieces of second identifier information is determined according to one of the following:
third indication information included in the second MAC CE command, where the third indication information is used to indicate a correspondence between a codepoint and second identifier information, or is used to indicate a correspondence between a TCI state activated by the second MAC CE command and second identifier information;
an association relationship between a location or a sequence of each TCI state in a plurality of TCI states corresponding to one codepoint and each piece of second identifier information; and
an association relationship between a location or a sequence of a codepoint and each piece of second identifier information.

Further, the radio frequency unit 701 is further configured to receive first configuration information, where the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

Further, third target identifier information is the first identifier information, or the third target identifier information is any one piece of identifier information in the at least two pieces of second identifier information; and
a configuration manner of the configuration includes at least one of the following:
an association relationship is established between the third target identifier information and configuration information of the joint TCI mode;
an association relationship is established between the third target identifier information and configuration information of the separate TCI mode;
the configuration information of the joint TCI mode is included in the third target identifier information;
the configuration information of the separate TCI mode is included in the third target identifier information;
the third target identifier information is included in the configuration information of the joint TCI mode; and
the third target identifier information is included in the configuration information of the separate TCI mode.

Further, the radio frequency unit 701 is further configured to receive target DCI, where the target DCI is used to indicate a target TCI state in the activated TCI states.

Further, the target DCI is DCI transmitted on a CORESET corresponding to fourth target identifier information, and is used to indicate a target TCI state corresponding to fifth target identifier information, where
the target TCI state is at least one of TCI states activated by a first target MAC CE command, and the first target MAC CE command is a first MAC CE command corresponding to the fifth target identifier information in the at least two first MAC CE commands.

Further, the target DCI is DCI transmitted on a CORESET corresponding to sixth target identifier information, and is used to indicate a target TCI state corresponding to each piece of second identifier information in the at least two pieces of second identifier information, where the sixth target identifier information is identifier information or any one piece of identifier information in the at least two pieces of second identifier information.

Further, the first MAC CE command includes a first signaling field, and the first signaling field is used to indicate the target TCI state in TCI states activated by the first MAC CE command; or
the second MAC CE command includes a first signaling field, and the first signaling field is used to indicate the target TCI state in TCI states activated by the second MAC CE command; or
the target DCI includes a first signaling field, and the first signaling field is used to indicate the target TCI state in TCI states corresponding to a codepoint indicated by a TCI field of the target DCI.

Further, whether the first MAC CE command includes the first signaling field is determined according to at least one of the following:
configuration information of the network side device; and
a quantity of TCI states activated by the first MAC CE command;
or
whether the second MAC CE command includes the first signaling field is determined according to at least one of the following:
configuration information of the network side device; and
a quantity of TCI states activated by the second MAC CE command;
or
whether the target DCI includes the first signaling field is determined according to at least one of the following:
configuration information of the network side device;
a quantity of TCI states activated by the first MAC CE command;
a quantity of TCI states activated by the second MAC CE command; and
a quantity of TCI states corresponding to the codepoint indicated by the TCI field of the target DCI.

Further, the first signaling field is used to indicate one of the following:
one joint TCI state, or one pair of separate TCI states, or one separate UL TCI state, or one separate DL TCI state in the TCI states activated by the first MAC CE command;
all TCI states activated by the first MAC CE command; and
all TCI states activated by the first MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states activated by the second MAC CE command;
all TCI states activated by the second MAC CE command; and
all TCI states activated by the second MAC CE command, and a sequence or a location of each TCI state;
or
the first signaling field is used to indicate one of the following:
one joint TCI state, or one pair of separate TCI states, or one separate UL TCI state, or one separate DL TCI state in the TCI states corresponding to the codepoint indicated by the TCI field of the target DCI;
all TCI states corresponding to the codepoint indicated by the TCI field of the target DCI; and
all TCI states corresponding to the codepoint indicated by the TCI field of the target DCI, and a sequence or a location of each TCI state.

Further, the target DCI is UL DCI.

Further, the first signaling field is a sounding reference signal SRS resource set indicator field in the UL DCI.

Further, the UL DCI is UL DCI for scheduling uplink transmission or UL DCI without uplink scheduling.

Further, in a case that the target TCI state includes a plurality of joint TCI states, and the plurality of joint TCI states are associated or include an uplink power control parameter, it is determined that a TRP mode is a multi-TRP scenario; or
in a case that the target TCI state includes a plurality of separate UL TCI states, and the plurality of separate UL TCI states are associated or include an uplink power control parameter, it is determined that a TRP mode is a multi-TRP scenario; or
in a case that the target TCI state indicated by the first signaling field corresponds to more than one piece of first identifier information or second identifier information, it is determined that a TRP mode is a multi-TRP scenario.

Further, in a case that the target TCI state includes a plurality of joint TCI states, and only one joint TCI state in the plurality of joint TCI states is associated with or includes an uplink power control parameter, it is determined that a TRP mode a single TRP scenario; or
in a case that the target TCI state includes a plurality of separate UL TCI states, and only one separate UL TCI state in the plurality of separate UL TCI states is associated with or includes an uplink power control parameter, it is determined that a TRP mode is a single TRP scenario; or
in a case that the target TCI state indicated by the first signaling field corresponds to one piece of first identifier information or second identifier information, it is determined that a TRP mode is a single TRP scenario.

An embodiment of this application further provides a network side device, including a processor and a communication interface. The communication interface is configured to send a Media Access Control control element MAC CE command, where the MAC CE command includes at least two first MAC CE commands or a second MAC CE command; the first MAC CE command is used to activate a transmission configuration indicator TCI state corresponding to one piece of first identifier information; the second MAC CE command is used to activate TCI states corresponding to at least two pieces of second identifier information; and the activated TCI state is used to determine common beam information of a plurality of channels. This network side device embodiment corresponds to the foregoing method embodiment on the network side device. Each implementation process and implementation of the foregoing method embodiment may be applicable to this network side device embodiment, and a same technical effect can be achieved.

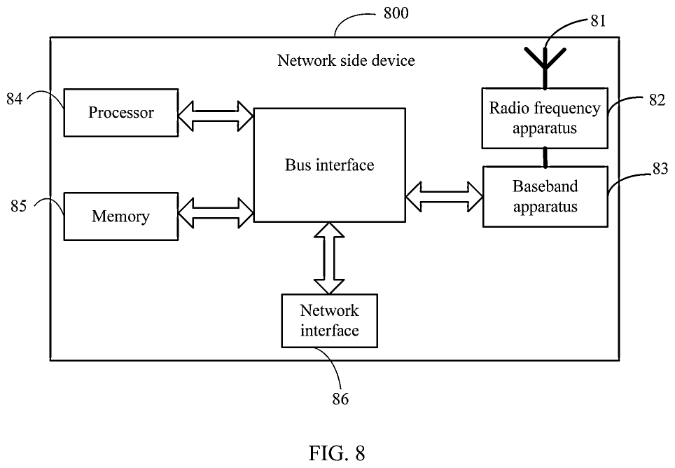

For example, an embodiment of this application further provides a network side device. As shown in FIG. 8, a network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in the baseband apparatus 83. The baseband apparatus 83 includes a baseband processor.

The baseband apparatus 83 may include, for example, at least one baseband board, where a plurality of chips are disposed on the baseband board. As shown in FIG. 8, one chip is, for example, the baseband processor, is connected to the memory 85 through a bus interface, to invoke a program in the memory 85 to perform the operations of the network device shown in the foregoing method embodiment.

The network side device may further include a network interface 86, and the interface is, for example, a Common Public Radio Interface (CPRI).

For example, the network side device 800 in this embodiment of the present application further includes an instruction or a program that is stored in the memory 85 and that can be run on the processor 84. The processor 84 invokes the instruction or the program in the memory 85 to perform the method performed by the modules shown in FIG. 4, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing information activation method embodiment shown in FIG. 2 or FIG. 3, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information activation method embodiment shown in FIG. 2 or FIG. 3, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product is stored in a storage medium, and the computer program product is executed by at least one processor to implement the processes of the foregoing information activation method embodiment, and a same technical effect can be achieved. To avoid repetition, details are not described herein again.

An embodiment of this application further provides a communication system, including a terminal and a network side device, where the terminal may be configured to perform the steps of the information activation method in the embodiment shown in FIG. 3, and the network side device may be configured to perform the steps of the information activation method in the embodiment shown in FIG. 2.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

1. An information activation method, comprising:
sending, by a network side device, a Media Access Control Control Element (MAC CE) command, wherein the MAC CE command comprises at least two first MAC CE commands or a second MAC CE command,
wherein:
the first MAC CE command is used to activate a Transmission Configuration Indicator (TCI) state corresponding to one piece of first identifier information,
the second MAC CE command is used to activate TCI states corresponding to at least two pieces of second identifier information, and
an activated TCI state is used to determine common beam information of a plurality of channels.

2. The information activation method according to claim 1,
wherein:
the first identifier information comprises at least one of the following:
Control Resource Set (CORESET) identifier information,
a CORESET Pool Index (CORESETPoolIndex),
Transmission Reception Point (TRP) identifier information,
channel group identifier information,
CORESET group identifier information, or
Physical Uplink Control Channel (PUCCH) resource group identifier information; and
the second identifier information comprises at least one of the following:
CORESET identifier information,
CORESETPoolIndex,
TRP identifier information,
channel group identifier information,
CORESET group identifier information, or
PUCCH resource group identifier information.

3. The information activation method according to claim 1, wherein when the network side device configures a joint TCI mode, each TCI state activated according to the first MAC CE command corresponds to one codepoint.

4. The information activation method according to claim 1, wherein when the network side device configures a separate TCI mode, each TCI state and codepoint activated according to the first MAC CE command meet one of the following:
one codepoint corresponds to one separate Downlink (DL) TCI state and one separate Uplink (UL) TCI state;
one codepoint corresponds to one separate DL TCI state; or
one codepoint corresponds to one separate UL TCI state.

5. The information activation method according to claim 1, wherein each TCI state and codepoint activated according to the first MAC CE command meet one of the following:
one codepoint corresponds to one joint TCI state;
one codepoint corresponds to one separate Downlink (DL) TCI state and one separate UL TCI state;
one codepoint corresponds to one separate DL TCI state; or
one codepoint corresponds to one separate Uplink (UL) TCI state.

6. The information activation method according to claim 5, wherein the first MAC CE command comprises first indication information, and the first indication information is used to indicate that a TCI state corresponding to a codepoint is one of the following:
the joint TCI state;
the separate DL TCI state and the separate UL TCI state;
the separate DL TCI state; or
the separate UL TCI state.

7. The information activation method according to claim 2, wherein a TCI state activated by the first MAC CE command is used for first identifier information indicated by the first MAC CE command.

8. The information activation method according to claim 1, wherein when the network side device configures a joint TCI mode, a TCI state and a codepoint activated according to the second MAC CE command meet one of the following:
one codepoint corresponds to at least two TCI states, and each TCI state in the at least two TCI states corresponds to different second identifier information; or
each codepoint corresponds to a TCI state corresponding to one piece of second identifier information, wherein
the TCI state corresponding to the second identifier information comprises one joint TCI state.

9. The information activation method according to claim 1, wherein when the network side device configures a separate TCI mode, a TCI state and a codepoint activated according to the second MAC CE command meet one of the following:
one codepoint corresponds to TCI states corresponding to a plurality of pieces of second identifier information; or
each codepoint corresponds to a TCI state corresponding to one piece of second identifier information, wherein
the TCI state corresponding to the second identifier information comprises at least one of one Downlink (DL) TCI state or one UL TCI state.

10. The information activation method according to claim 1,
wherein:
first target identifier information comprises a part of second identifier information in the at least two pieces of second identifier information, and the second target identifier information is other second identifier information in the at least two pieces of second identifier information except the first target identifier information; and
when the network side device configures a joint TCI mode for the first target identifier information and configures a separate TCI mode for the second target identifier information, a TCI state and a codepoint activated according to the second MAC CE command meet one of the following:
one codepoint corresponds to a TCI state corresponding to the first target identifier information and a TCI state corresponding to the second target identifier information; or
a first codepoint corresponds to the TCI state corresponding to the first target identifier information, and a second codepoint corresponds to the TCI state corresponding to the second target identifier information, wherein the first codepoint is a part of codepoints in codepoints activated by the second MAC CE command, and the second codepoint is a codepoint in the codepoints activated by the second MAC CE command except the first codepoint.

11. The information activation method according to claim 1, wherein each TCI state and codepoint activated according to the second MAC CE command meet one of the following:
a TCI state corresponding to one codepoint comprises a TCI state corresponding to each piece of second identifier information in the at least two pieces of second identifier information, wherein the TCI state corresponding to the second identifier information comprises one of a joint TCI state, a separate Downlink (DL) TCI state and a separate Uplink (UL) TCI state, a separate DL TCI state, and a separate UL TCI state; or
a third codepoint corresponds to a TCI state corresponding to one piece of second identifier information, and a fourth codepoint corresponds to a TCI state corresponding to another piece of second identifier information, wherein the third codepoint and the fourth codepoint are different codepoints in codepoints activated by the second MAC CE command, the TCI state corresponding to the one piece of second identifier information comprises a joint TCI state, and the TCI state corresponding to the another piece of second identifier information comprises at least one of one separate DL TCI state or one separate UL TCI state.

12. The information activation method according to claim 5, wherein at least two of the joint TCI state, the separate DL TCI state, and the separate UL TCI state are from different TCI state pools.

13. The information activation method according to claim 11, wherein the second MAC CE command comprises second indication information, and the second indication information is used to indicate that a TCI state corresponding to a codepoint is one of the following:
the joint TCI state;
the separate DL TCI state and the separate UL TCI state;
the separate DL TCI state; or
the separate UL TCI state.

14. The information activation method according to claim 1, wherein a correspondence between a TCI state activated by the second MAC CE command and the at least two pieces of second identifier information is determined according to one of the following:
third indication information comprised in the second MAC CE command, wherein the third indication information is used to indicate a correspondence between a codepoint and second identifier information, or is used to indicate a correspondence between a TCI state activated by the second MAC CE command and second identifier information;
an association relationship between a location or a sequence of each TCI state in a plurality of TCI states corresponding to one codepoint and each piece of second identifier information; or
an association relationship between a location or a sequence of a codepoint and each piece of second identifier information.

15. The information activation method according to claim 1, further comprising: sending, by the network side device, first configuration information, wherein
the first configuration information is used to configure a joint TCI mode or a separate TCI mode for at least one piece of first identifier information in first identifier information corresponding to the at least two first MAC CEs, or the first configuration information is used to configure a joint TCI mode or a separate TCI mode for at least one piece of second identifier information in second identifier information corresponding to the second MAC CE.

16. The information activation method according to claim 15, wherein third target identifier information is the first identifier information, or the third target identifier information is any one piece of identifier information in the at least two pieces of second identifier information; and
a configuration manner of the configuration comprises at least one of the following:
an association relationship is established between the third target identifier information and configuration information of the joint TCI mode;
an association relationship is established between the third target identifier information and configuration information of the separate TCI mode;
the configuration information of the joint TCI mode is comprised in the third target identifier information;
the configuration information of the separate TCI mode is comprised in the third target identifier information;
the third target identifier information is comprised in the configuration information of the joint TCI mode; or
the third target identifier information is comprised in the configuration information of the separate TCI mode.

17. The information activation method according to claim 1, further comprising:
sending, by the network side device, target DCI, wherein the target DCI is used to indicate a target TCI state in the activated TCI states.

18. The information activation method according to claim 17,
wherein:
the target DCI is DCI transmitted on a Control Resource Set (CORESET) corresponding to fourth target identifier information, and is used to indicate a target TCI state corresponding to fifth target identifier information, wherein both the fourth target identifier information and the fifth target identifier information are the first identifier information; and
the target TCI state is at least one of TCI states activated by a first target MAC CE command, and the first target MAC CE command is a first MAC CE command corresponding to the fifth target identifier information in the at least two first MAC CE commands.

19. A network side device, comprising: a processor; and a memory having a computer program or an instruction stored thereon, wherein the computer program or the instruction, when executed by the processor, causes the processor to implement operations, comprising:
sending a Media Access Control Control Element (MAC CE) command, wherein the MAC CE command comprises at least two first MAC CE commands or a second MAC CE command,
wherein:
the first MAC CE command is used to activate a Transmission Configuration Indicator (TCI) state corresponding to one piece of first identifier information,
the second MAC CE command is used to activate TCI states corresponding to at least two pieces of second identifier information, and
an activated TCI state is used to determine common beam information of a plurality of channels.

20. A non-transitory computer-readable storage medium storing a computer program or an instruction that, when executed by a processor, causes the processor to implement operations, comprising:
sending a Media Access Control Control Element (MAC CE) command, wherein the MAC CE command comprises at least two first MAC CE commands or a second MAC CE command,
wherein:
the first MAC CE command is used to activate a Transmission Configuration Indicator (TCI) state corresponding to one piece of first identifier information,
the second MAC CE command is used to activate TCI states corresponding to at least two pieces of second identifier information, and
an activated TCI state is used to determine common beam information of a plurality of channels.
